(19) United States
(12) Patent Application Publication
(10) Pub. No.: US 2019/0259200 A1
(43) Pub. Date: Aug. 22, 2019

(54) UTILIZING DISTANCE FIELDS FOR OCCLUSION DETERMINATION IN COMPUTER GENERATED SCENERY

(71) Applicant: Microsoft Technology Licensing, LLC, Redmond, WA (US)

(72) Inventor: Jonathan R. HOOF, Kenmore, WA (US)

(21) Appl. No.: 15/901,745

(22) Filed: Feb. 21, 2018

(51) Int. Cl. G06T 15/40

(52) U.S. Cl. CPC G06T 15/40

(57) ABSTRACT

A distance field approach is used to determine when we lose the line of sight from a view point to a given pixel (or voxel) in the presence of occluding pixels (voxels). Distance values computed by the propagating the distance field can be compared to linear distances. When the linear distance differs from the propagated distance value by a given amount, the pixel (voxel) can be deemed to be occluded.

### BACKGROUND

Computer generated scenes typically involve spatially partitioning the scene into a suitable grid of cells. In a 2-dimensional (2D) system, the cells comprising the partitioned scene can be referred to as pixels, while in a 3D system the cells can be referred to as voxels (a portmanteau of volume element). Each cell can then be rendered to produce the desired scene. The rendered scene is typically from the point of view of a viewer, for example, a camera view, the viewpoint of player, and so on. Accordingly, not all the objects in the scene are likely to be visible along the line of sight of the viewer. Improvements in the processing speed of rendering or otherwise generating the scene can be realized by not rendering those cells in the scene that are not visible along the line of sight of the viewer. For example, the cells that represent a flower pot positioned behind a box (relative to the viewer) will not be visible to the viewer because the cells that represent the box occlude the flower pot cells, and so the flower pot cells need not be rendered. The challenge then becomes one of being able to efficiently identify those cells in the partitioned scene that are not visible (i.e., occluded) by the viewer.

### SUMMARY

Aspects of the present disclosure include propagating a distance field through a spatial partitioning that represents a scene to be rendered, and in particular the distance field is propagated from a viewer (e.g., camera, game player, etc.) in the scene. The path distances of cells comprising the spatial partitioning are compared to their linear distances from the viewer. Cells whose distance differences exceed a predetermined threshold can be deemed to be occluded, and hence need not be rendered.

In some embodiments in accordance with the present disclosure, an apparatus comprises one or more computer processors, and a computer-readable storage medium comprising instructions for controlling the one or more computer processors to be operable to: generate a spatial partitioning that is representative of a scene, the spatial partitioning comprising a plurality of cells including a starting cell, a plurality of occluding cells, and a plurality of non-occluding cells; associate a path distance value for each non-occluding cell that is representative of a minimum path distance between said each non-occluding cell and the starting cell; identify occluded cells from among the plurality of non-occluding cells using the minimum path distance value associated with each non-occluding cell and a linear distance value between said each non-occluding cell and the starting cell; and produce a computer generated representation of the scene using non-occluding cells that are not identified as occluded cells.

In some embodiments, identifying occluded cells includes, for each non-occluding cell, the one or more computer processors are operable to: compute a difference between the minimum path distance value associated with said each non-occluding cell and the linear distance value between said each non-occluding cell and the starting cell; and designate said each non-occluding cell as an occluded cell when the difference is greater than a predetermined value.

In some embodiments, the spatial partitioning further comprises a starting set of cells, wherein the computer-readable storage medium further comprises instructions for controlling the one or more computer processors to be operable to select the starting cell from the starting set of cells.

In some embodiments, associating a path distance value for each non-occluding cell comprises propagating a distance field from the starting cell using a fast marching algorithm.

In some embodiments, the starting cell corresponds to a view point in the scene and the occluding cells correspond to objects in the scene.

In some embodiments, producing the computer generated representation of the scene includes rendering only those non-occluding cells that are not identified as occluded cells.

In some embodiments, producing the computer generated representation of the scene includes performing surface reconstruction using the non-occluding cells to produce a virtual reality scene, including omitting reconstruction of surfaces that correspond to non-occluding cells that are identified as occluded cells.

In some embodiments, the computer generated representation of the scene is a scene in a computer game, wherein the computer-readable storage medium further comprises instructions for controlling the one or more computer processors to be operable to control an artificial intelligence game player to ignore objects corresponding to non-occluding cells that are identified as occluded cells.

In some embodiments in accordance with the present disclosure, a method for a computer generated scene, comprises: generating a spatial partitioning that is representative of a scene, the spatial partitioning comprising a plurality of cells including a starting cell, a plurality of occluding cells, and a plurality of non-occluding cells; associating a path distance value for each non-occluding cell that is representative of a minimum path distance between said each non-occluding cell and the starting cell; identifying occluded cells from among the plurality of non-occluding cells using the minimum path distance value associated with each non-occluding cell and a linear distance value between said each non-occluding cell and the starting cell; and producing a computer generated representation of the scene using non-occluding cells that are not identified as occluded cells.

In some embodiments, identifying occluded cells includes for each non-occluding cell: computing a difference between the minimum path distance value associated with said each non-occluding cell and the linear distance value between said each non-occluding cell and the starting cell; and designating said each non-occluding cell as an occluded cell when the difference is greater than a predetermined value.

In some embodiments, the spatial partitioning further comprises a starting set of cells, wherein the method further comprises selecting the starting cell from the starting set of cells.

In some embodiments, the starting cell corresponds to a view point in the scene and the occluding cells correspond to objects in the scene.

In some embodiments, producing the computer generated representation of the scene includes rendering only those non-occluding cells that are not identified as occluded cells.

In some embodiments, producing the computer generated representation of the scene includes performing surface reconstruction using the non-occluding cells to produce a virtual reality scene while omitting reconstruction of surfaces that correspond to non-occluding cells that are identified as occluded cells.

In some embodiments, the computer generated representation of the scene is a scene in a computer game, the method further including controlling an artificial intelligence game player to ignore objects corresponding to non-occluding cells that are identified as occluded cells.

In some embodiments, the spatial partitioning is a grid of cells.

In some embodiments in accordance with the present disclosure, a computer-readable storage medium having stored thereon computer executable instructions, which when executed by a computer device, cause the computer device to: generate a spatial partitioning that is representative of a scene to be rendered, the spatial partitioning comprising a plurality of cells including a starting cell, a plurality of occluding cells, and a plurality of non-occluding cells; associate a path distance value for each non-occluding cell that is representative of a minimum path distance between said each non-occluding cell and the starting cell; identify occluded cells from among the plurality of non-occluding cells using the minimum path distance value associated with each non-occluding cell and a linear distance value between said each non-occluding cell and the starting cell; and render the scene by rendering only those non-occluding cells that are not identified as occluded cells.

In some embodiments, identifying occluded cells includes for each non-occluding cell: computing a difference between the minimum path distance value associated with said each non-occluding cell and the linear distance value between said each non-occluding cell and the starting cell; and designating said each non-occluding cell as an occluded cell when the difference is greater than a predetermined value.

In some embodiments, the spatial partitioning further comprises a starting set of cells, wherein the computer executable instructions, which when executed by the computer device, further cause the computer device to select the starting cell from the starting set of cells.

In some embodiments, the computer generated representation of the scene is a scene in a computer game, wherein the computer executable instructions, which when executed by the computer device, further cause the computer device to control an artificial intelligence game player to ignore objects corresponding to non-occluding cells that are identified as occluded cells.

The following detailed description and accompanying drawings provide further understanding of the nature and advantages of the present disclosure.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts a high level block diagram of a computing environment in accordance with some embodiments of the present disclosure.

FIG. 1A depicts a high level block diagram of a computing environment in accordance with other embodiments of the present disclosure.

FIG. 1B depicts a high level block diagram of a computing environment in accordance with still other embodiments of the present disclosure.

FIG. 2 illustrates an example of a scene to be rendered.

FIG. 3 illustrates an example of a spatial partitioning of the scene in FIG. 2.

FIGS. 4 and 4A represent a high level process that outlines operations for rendering a scene in accordance with the present disclosure.

FIG. 5A shows an initial grid configuration in accordance with the present disclosure.

FIG. 5B shows the grid of FIG. 5A after propagating a distance field through the grid.

FIG. 5C shows the distance field values.

FIG. 6 illustrates additional details of a distance field in accordance with some embodiments of the present disclosure.

FIG. 7 depicts a simplified block diagram of an example computer system according to certain embodiments.

### DETAILED DESCRIPTION

Embodiments in accordance with the present disclosure provide methods and systems to improve the processing efficiency in identifying cells comprising a spatially partitioned scene that are occluded from the point of view of a starting cell (a viewer) due to being obstructed along a line of sight of the starting cell. A distance field is propagated through the spatial partitioning, thus assigning or otherwise associating cells in the spatial partitioning with a path distance value. For a given cell, its linear distance to the starting cell can be compared with its path distance to determine if the cell is occluded or not.

Occlusion detection in accordance with embodiments of the present disclosure can be performed in O(n) time. In other words, the processing time for occlusion detection increases only linearly with the size of the grid, and in particular with the number (n) of non-occluding cells in the grid since occlusion determination can be made on each cell independently of other cells. The number of operations increases only by a factor of n, the number of non-occluding cells. This improves the functioning of the computer for rendering computer generated scenery because the time to perform occlusion detection is largely unaffected by the complexity of the scenery. The processing times are comparable whether the scene comprises only one object that occludes another object, or whether the scene comprises a thousand objects occluding each other in various ways.

The O(n) time performance of occlusion detection processing in accordance with the present disclosure allows processing of higher resolution scenery without causing the computer to “blow up” computationally, as could happen for example if the processing time increased exponentially with the size of the grid. Occlusion detection in accordance with embodiments of the present disclosure, therefore, improves the functioning of the computer in terms of allowing for the rendering of high resolution scenery in a reasonable time.

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples, alone or in combination with other features described below, and may further include modifications and equivalents of the features and concepts described herein.

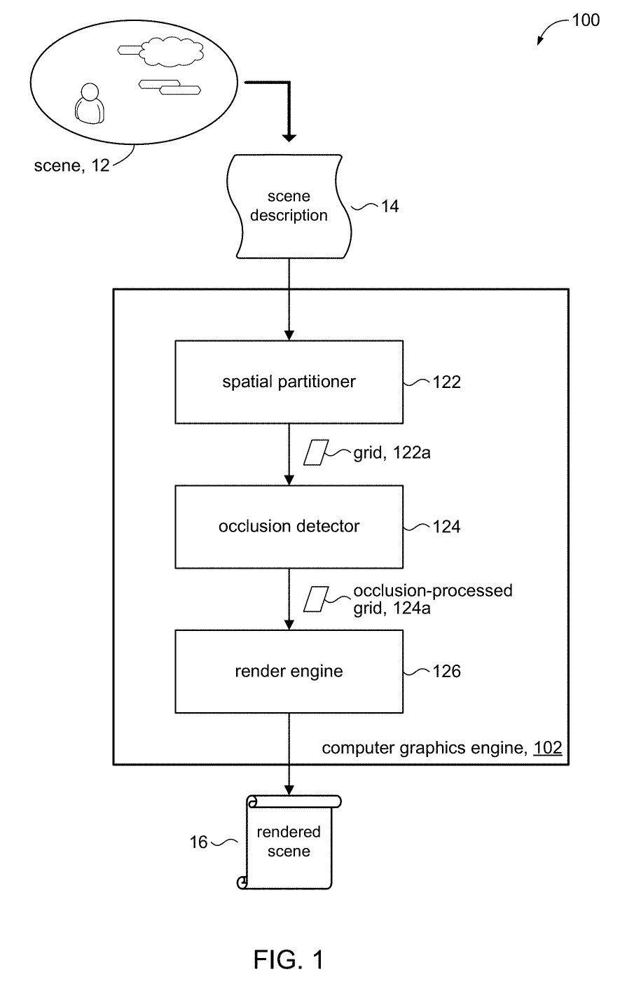

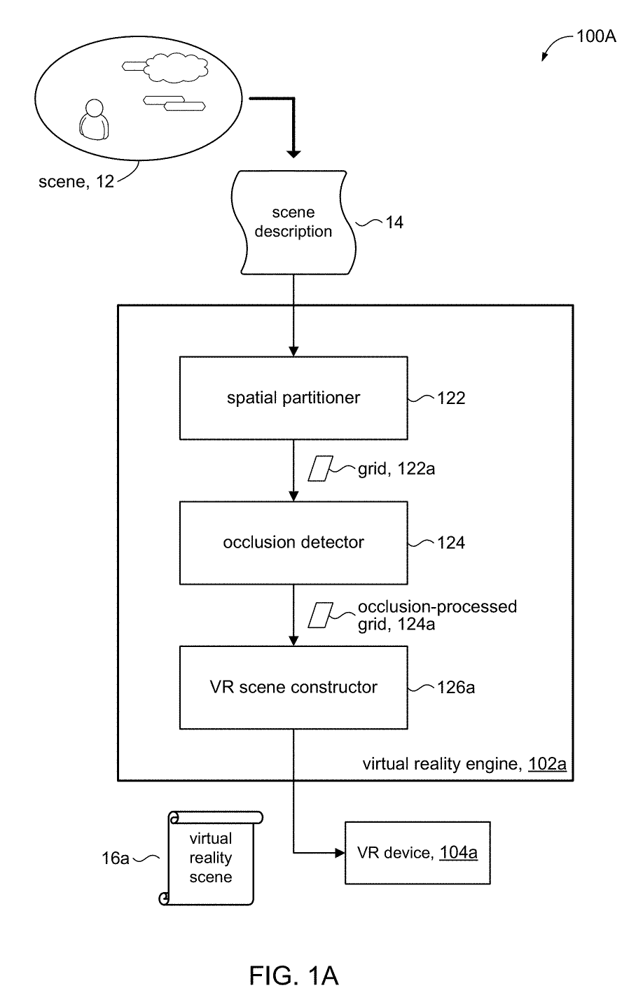

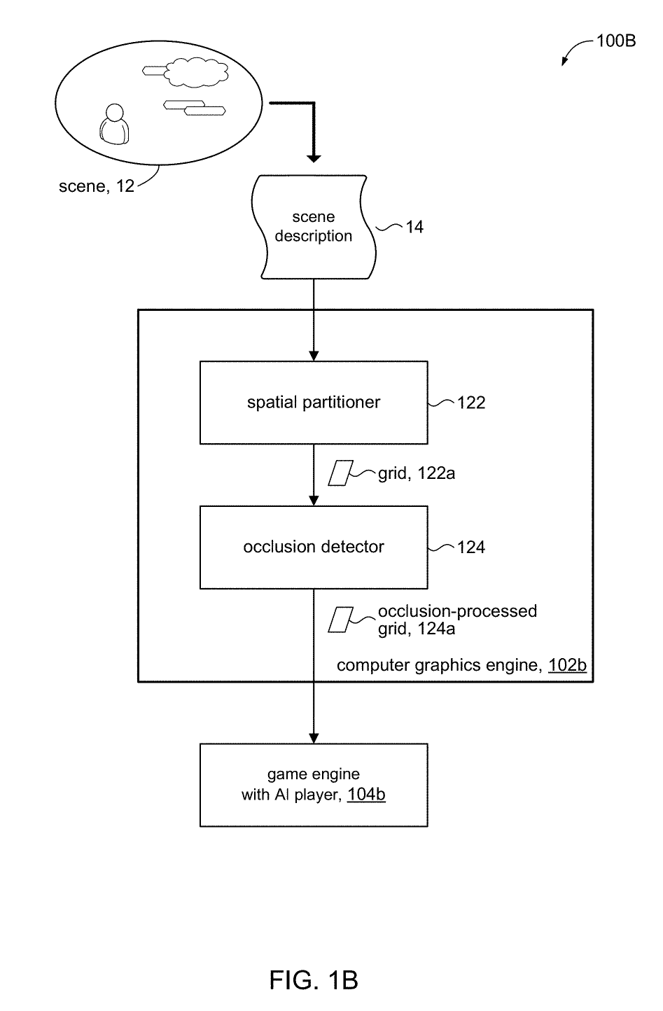

FIG. 1 represents a high-level simplified block diagram of a computing environment 100 in accordance with the present disclosure. In some embodiments, for example, the computing environment 100 can include a computer graphics engine 102 configured to receive a scene description 14 that represents a desired scene 12 and produce a computer generated representation of the scene (rendered scene 16) in accordance with the present disclosure. The scene description 14 can include information that identifies elements (objects) in the scene 12. The scene description 14 can include information that identifies a location within the scene 12 (e.g., a view point) from which the scene can be viewed, for example, the location of camera, the location of a game player, and the like.

The computer graphics engine 102 can include a spatial partitioner 122 configured to partition the scene 12 into a plurality of spatial partitions. In some embodiments, for example, the spatial partitioner 122 can partition the scene 12 into a grid of cells defined on a Cartesian coordinate system. In some embodiments, the grid can be a 2-dimensional (2D) grid where the cells in the grid can be referred to as pixels. In other embodiments, the grid can be 3-dimensional (3D), comprising cells referred to as voxels. In other embodiments, the scene 12 can be represented using any suitable basis for partitioning the scene; for example, the partitioning can be based on a polar coordinate system and the like. The terms “grid” and “cells” will be used to refer to the partitioned scene irrespective of how the scene 12 is partitioned. The spatial partitioner 122 can generate a grid 122a that represents the scene as a plurality of cells. The spatial partitioner 122 can use information in the scene description 14 to identify cells that comprise the various objects in the scene 12.

The computer graphics engine 102 can include an occlusion detector 124 configured in accordance with the present disclosure to identify cells in the grid 122a that are occluded by other cells. The occlusion detector 124 can generate an occlusion-processed grid 124a in accordance with the present disclosure that can be used to facilitate and speed up rendering or other processing of the scene 12.

In some embodiments, the computer graphics engine 102 can include a render engine 126 configured to render the scene 12 using the occlusion-processed grid 124a and information contained in the scene description 14. As will become apparent in the following discussions, embodiments in accordance with the present disclosure can yield fast occlusion determination processing, and thus significantly improve processing speed in the computing environment in terms of rendering computer generated scenery irrespective of scene complexity.

The computing environment 100 described above is directed to rendering systems. It will be appreciated from the discussion above that the present disclosure can be embodied in computing environments other than for rendering. Referring to FIG. 1A, for example, in some embodiments the present disclosure can be incorporated in a virtual reality system 100A comprising a virtual reality engine 102a configured to produce a computer generated representation of the scene (virtual reality scene 16a). The virtual reality engine 102a can include a VR scene constructor 126a that takes the occlusion-processed grid 124a to perform surface reconstruction in the virtual reality scene 16a, which can then be displayed via a VR device 104a worn by a user. Processing of surface reconstructions can be improved by quickly identifying hidden or otherwise occluded surfaces using the occlusion determination processing of the present disclosure, which in turn can improve real-time processing in the virtual reality system to enhance the user's virtual reality experience.

Referring to FIG. 1B, in some embodiments, the present disclosure can be incorporated in a gaming system 100B that uses artificial intelligence (AI) game players. The gaming system 100B can include a computer graphics engine 102b that outputs the occlusion-processed grid 124a of a scene 12 to a game engine 104b that supports AI players. An AI player should not be able to see through an opaque object. For example, the AI player should not be able to “see” another player hiding behind a rock. Occlusion determination processing which identifies cells as “can be seen by the camera” in accordance with the present disclosure can speed up the processing of the AI player to query if it has direct line of sight to the player/camera in order to achieve realistic game play and thus improve live-action play experience. The game engine 104b can use the occlusion-processed grid 124a as a computer representation of the scene 12 during game play to determine whether an AI player can see behind an object or not.

The remaining discussion will explain the present disclosure in the context of rendering a scene. It will be appreciated from the foregoing, however, that occlusion determination in accordance with the present disclosure has application in use cases such as described above, and more generally in use cases where occluded regions in a scene relative to a view point need to be identified.

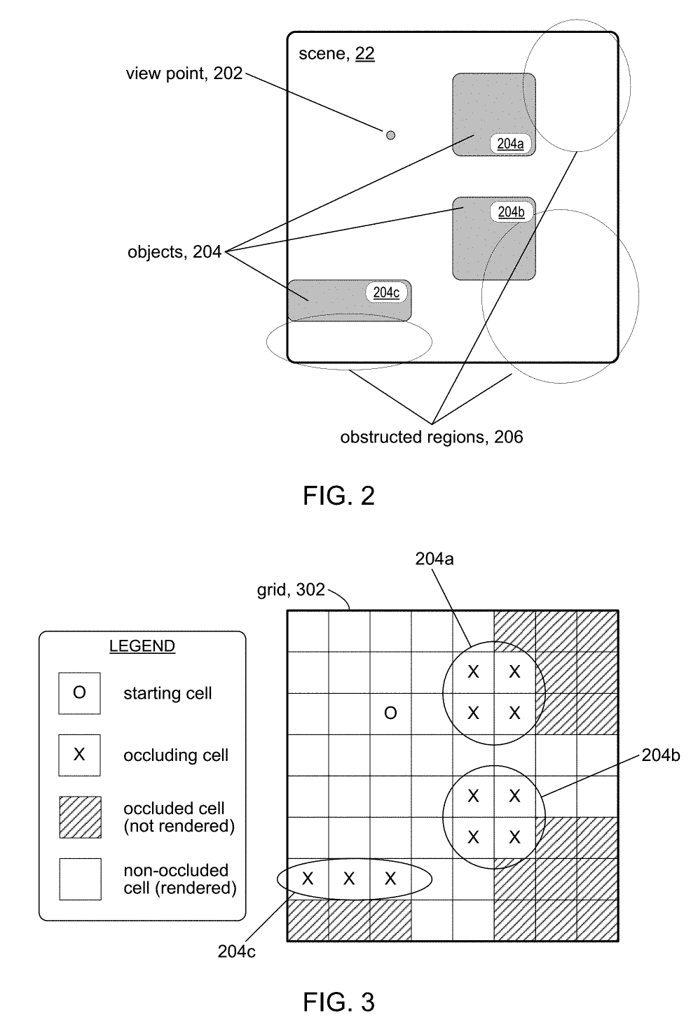

Referring to FIG. 2, an illustrative example of a scene 22 is depicted for discussion purposes. Although the scene 22 is a 2D scene, one of ordinary skill will be able to adapt the present disclosure to a 3D scene. The scene 22 may comprise objects 204 that exist within the environment of the scene. The scene 22 can be viewed from a view point 202. If the objects 204 are opaque, then there will be regions (e.g., obstructed regions 206) in the scene 22 behind the objects 204a, 204b that are obstructed when viewed (e.g., by a camera view, a player and so on) from view point 202. In some embodiments, objects 204 or portions of objects that are not completely opaque can be deemed to be transparent, since a viewer at the view point 202 can view the region behind the transparent portions.

Referring to FIG. 3, a spatial partitioning of the scene 22 (FIG. 2) can produce a grid 302. The grid 302 is based on a Cartesian coordinate system, but as noted above, a scene can be partitioned in any suitable manner that can provide an approximation/sampling of the scene. The grid 302 comprises a set of cells, and in the example depicted in FIG. 3, the grid 302 is an 8×8 grid of cells, although in practice grids of higher resolution can be used.

The elements in the scene 22 can be approximated by cells that comprise the grid 302. For example, the view point 202 can be represented by a cell in the grid 302, which will be referred to as “starting cell” for reasons that will become clear below. The objects 204 in scene 22 can be represented by groups of cells in the grid 302. For purposes of discussion, objects 204 can be assumed to be opaque. Cells corresponding to objects 204 can be referred to as “occluding cells” since they occlude (block) the line-of-sight view from view point 202. Each object 204a, 204b, 204c in scene 22 is represented by a corresponding group of cells in grid 302. The obstructed regions 206 can be represented by cells referred to as “occluded cells” because those cells are occluded from view point 202 by the occluding cells. Finally, cells that are not blocked from view point 202 can be referred to as “non-occluded cells.” As noted above, some objects or portions of an object may not be completely opaque (e.g., fully or partially transparent). Accordingly, in some embodiments, the cells in grid 302 that correspond to such objects or portions of an object can be deemed non-occluding cells for purposes of the present disclosure.

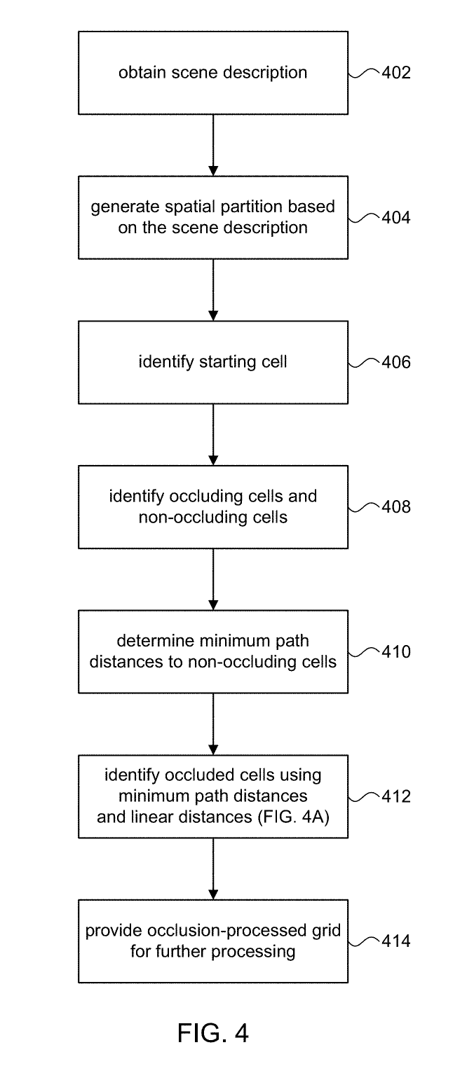

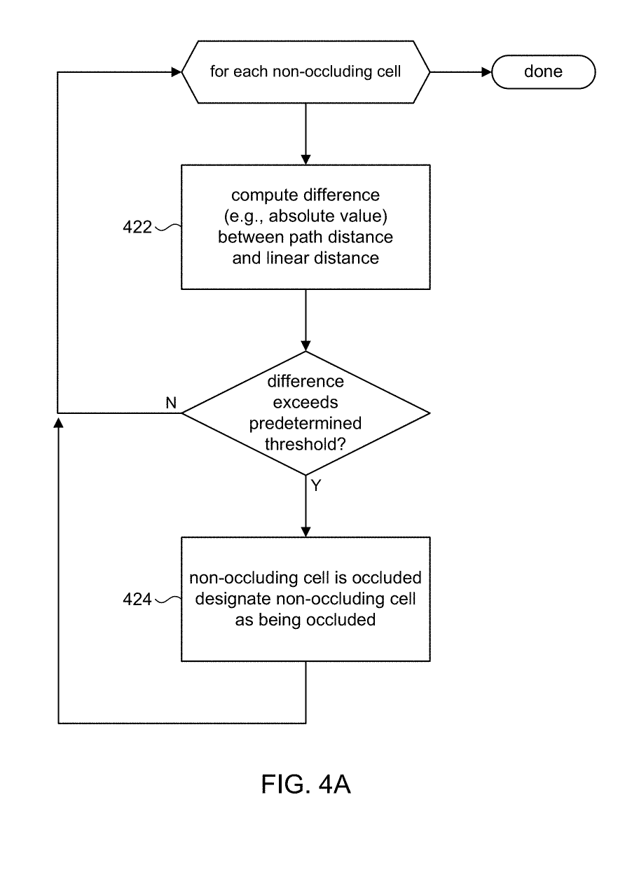

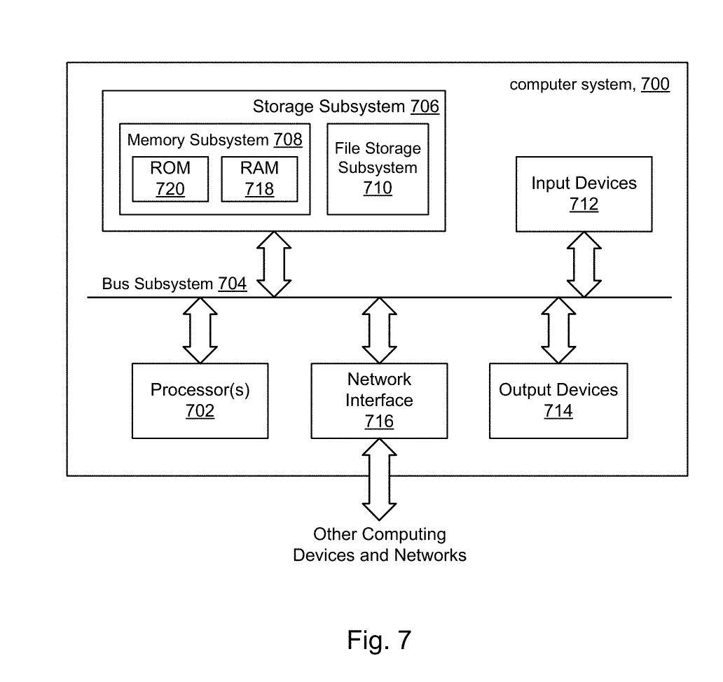

Referring to FIG. 4, the discussion will now turn to a high level description of processing in the occlusion detector 124 (FIG. 1) for detecting occluded cells in accordance with the present disclosure. In some embodiments, for example, the occlusion detector 124 can include computer executable program code, which when executed by a computer system (e.g., 702, FIG. 7), can cause the computer system to perform processing in accordance with FIG. 4. The flow of operations performed by the computer system is not necessarily limited to the order of operations shown.

At operation 402, the occlusion detector can obtain a scene description (e.g., 14, FIG. 1) comprising information about the scene to be rendered. The scene can be a 2D scene or a 3D scene, but for explanation purposes a 2D scene will be used. In some embodiments, for example, the scene description can include information about objects in the scene and their locations in the scene. The scene description can include parameters such as grid resolution. For example, the grid resolution of grid 302 (FIG. 3) is 8×8, but in practice the grid resolution can be higher. The parameters can also include a location of the view point (e.g., 202, FIG. 2) within the scene.

At operation 404, the occlusion detector can generate a spatial partitioning of the scene. As noted above, any suitable spatial partitioning can be used. For purposes of explanation, the occlusion detector can generate a grid based on Cartesian coordinates without loss of generality. In some embodiments, the number of cells comprising the grid can be determined from the grid resolution parameter received at operation 402. The example used herein will assume an 8×8 grid, but as explained above, higher spatial resolutions can be used.

At operation 406, the occlusion detector can identify or otherwise mark a cell in the generated grid as a starting cell. In some embodiments, the starting cell can correspond to the spatial location of the view point in the scene. In other embodiments, a starting set of cells in the generated grid can be identified. A starting set of cells may be suitable for an orthographic camera, where the starting set of cells define a pseudo-plane representing a plane perpendicular to the camera's look direction, and set some distance away from the objects in the scene. The distance field would propagate in a plane, perturbed by occluding objects. Such a system can be used to simulate shadows in the case of sunshine, as light from the sun is parallel and can be computed via an orthographic camera for shadow purposes.

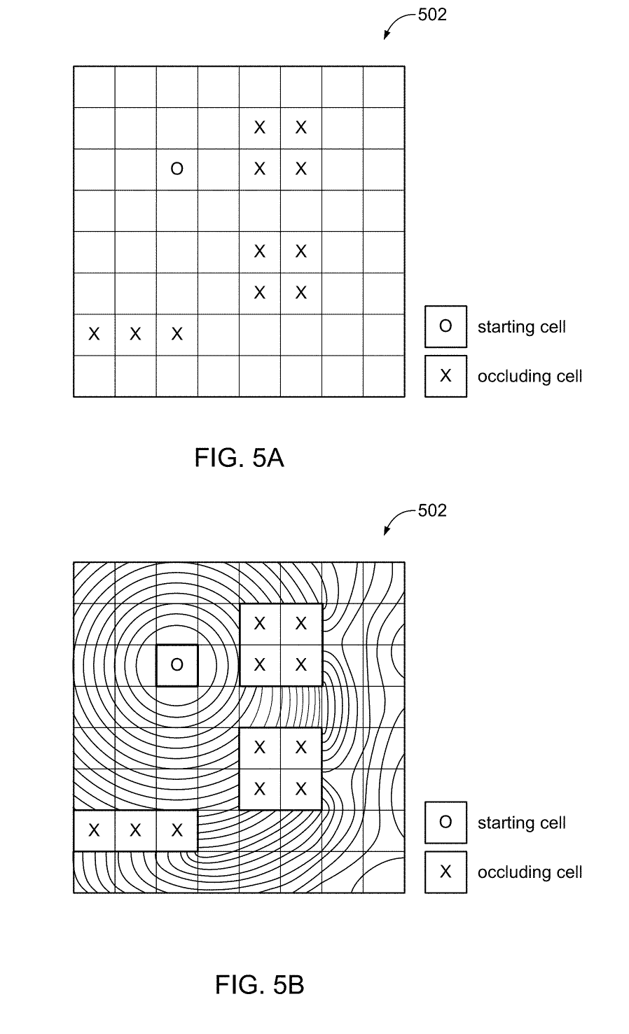

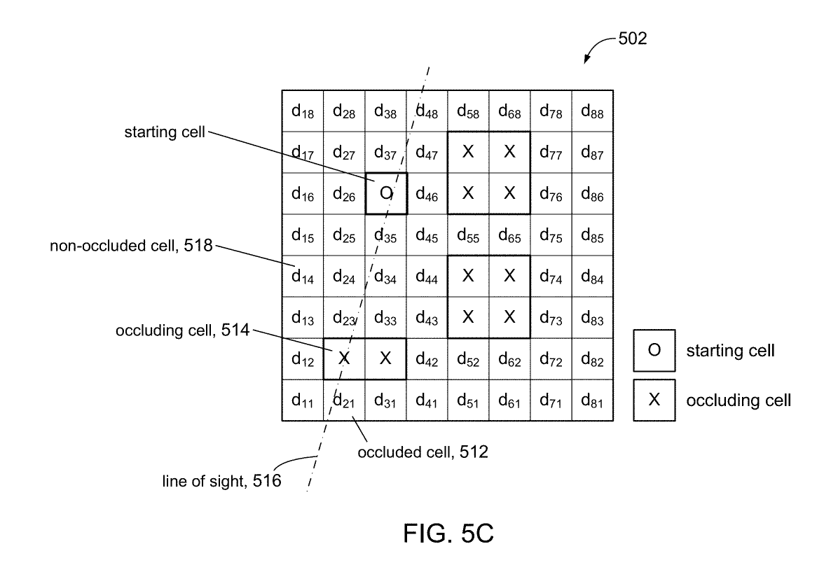

At operation 408, the occlusion detector can identify or otherwise mark cells in the generated grid that correspond to objects in the scene as occluding cells. In some embodiments, for example, the scene description can include information about the locations of the objects. All cells enclosed by the object can be marked as occluding cells. In the case of a 2D scene, for example, an object encloses an area and so the cells contained in that area can be marked as occluding cells. In the case of a 3D scene, an object encloses a volume and so cells contained in the volume can be marked as occluding cells. Referring for a moment to FIG. 5A, the figure illustrates the configuration of a grid 502 that represents an initial spatial partitioning of a 2D scene to be rendered in accordance with some embodiments. The grid 502 shows a cell that is marked as the starting cell (corresponding to the view point in the scene, marked with an “O”) and cells that are marked as occluding cells (corresponding to objects in the scene, marked with “X”s).

At operation 410, the occlusion detector can propagate a distance field in the grid from the starting cell (i.e., view point) to assign or otherwise associate a path distance from the starting cell for each of the non-occluding cells. Techniques for propagating the distance field in a grid are known by those of skill in the art. In some embodiments, for example, the occlusion detector can use a class of algorithms called level set methods to generate a distance field. In other embodiments, a distance field can be propagated across the grid using a method called the fast marching algorithm, which is an example of a wave-front propagating type distance field. In still other embodiments, a numerical technique called the fast sweeping method can be used to propagate a distance field. Still other techniques are available, and embodiments of the present disclosure can employ any suitable technique.

Referring for a moment to FIG. 5B, the grid 502 is shown with a schematic depiction of a propagated distance field emanating from the starting cell for explanation purposes. In some embodiments, the distance field can be viewed as a continuous field of points, with each point being associated with a path distance that is measured along a path between the point and the starting cell. FIG. 5B represent points comprising the distance field in terms of a set of isometric lines superimposed on the cells comprising the grid 502. Each point on a given isometric line has the same path distance value as measured from the starting cell. These aspects of the present disclosure are discussed in more detail below.

In accordance with some embodiments, each cell in the grid 502 can be assigned or otherwise associated with path distance value. In some embodiments, for example, a cell's path distance from the starting cell can be based on the isometric line that passes through the center of that cell. In other embodiments, the cell's path distance can be determined by combining the path distances of two or more isometric lines passing through that cell; e.g., taking an average. FIG. 5C shows the grid 502 with assigned path distance values. It is noted that although the grid 502 is quantized in the sense that it is partitioned into discrete cells, the path distance values can nonetheless be assigned real number values due to the continuous nature of the distance field.

Continuing with FIG. 4, at operation 412, the occlusion detector can identify occluded cells from among the non-occluding cells in the grid. Referring to FIG. 5C, for example, in some embodiments the cells that are not the starting cell (marked by “O”) or the occluding cells (marked by “X”) can be deemed “non-occluding cells” in the sense that those cells would not occlude a viewer's line of sight from the starting cell in the absence of any occluding cells. However, a non-occluding cell (e.g., cell 512) can nonetheless be deemed to be occluded, for example, by virtue of the presence of an occluding cell (e.g., cell 514) located between the non-occluding cell 512 and the starting cell along a line of sight 516. By comparison, a non-occluding cell (e.g., cell 518) would not be deemed to be occluded since there is an unobstructed line of sight from the starting cell.

In accordance with the present disclosure, the occlusion detector can identify occluded cells based on their respective path distances to the starting cell (computed or otherwise determined at operation 410) and their respective linear distances to the starting cell. In some embodiments, the absolute value of the difference between path distance and linear distance can be computed (e.g., FIG. 4A, 422) to determine whether a non-occluding cell is also an occluded cell or not. In a particular instance, if the difference is greater than a predetermined threshold value, then that non-occluding cell can be designated as being an occluded cell (FIG. 4A, 424). These aspects of the present disclosure are discussed further below.

In some embodiments, operations 410 and 412 can be combined. As discussed above, the distance field can be propagated across the scene (operation 410) in a separate operation before the operation of identifying occluded cells (operation 412). However, it will be appreciated that in other embodiments, the identification of occluded cells can be performed as part of the process of propagating the distance field. For example, in some embodiments, both the path distance and the linear distance can be determined for each non-occluding cell in the same operation, and during that operation the non-occluding cell can be assessed for whether it is occluded or not. An advantage for computing the linear and propagated distance at the same time allows the distance field propagation process to terminate early for a given cell when it is clear that the cell is occluded and any further propagation from that cell will thus also be occluded. In the case of a wave-front propagating type distance field computation, this can reduce the propagation time.

At operation 414, the occlusion detector can provide the occlusion-processed grid for further processing. In some embodiments, for example, the occlusion-processed grid can be provided to a render engine (e.g., 126, FIG. 1) to render a computer generated representation of the scene comprising only those non-occluding cells that are not identified as occluded cells. The rendering speed can be significantly improved because the cells that are identified or otherwise marked as being occluded need not be rendered.

In other embodiments, the occlusion-processed grid can be processed in a VR system (e.g., FIG. 1A). For example, surface reconstruction can be performed using the non-occluding cells to produce a virtual reality scene where surfaces that correspond to non-occluding cells that are identified as occluded cells can be omitted. The occluded cells correspond to hidden surfaces that need not be reconstructed in the VR scene and so their reconstruction can be omitted, thus improving the speed of generating the user's virtual reality surroundings and thus enhance the user's VR experience.

In still other embodiments, the occlusion-processed grid can provide a computer generated representation of the scene in a gaming system. The gaming system can use the identified occluded cells to understand that certain game elements are opaque to an AI game player and objects corresponding to non-occluding cells that are identified as occluded cells should not be visible to the AI player. The gaming system can control the AI game player can to ignore such objects during game play so that it appears to a human user that the AI game player cannot see behind the objects, thus providing realistic game play for the human players.

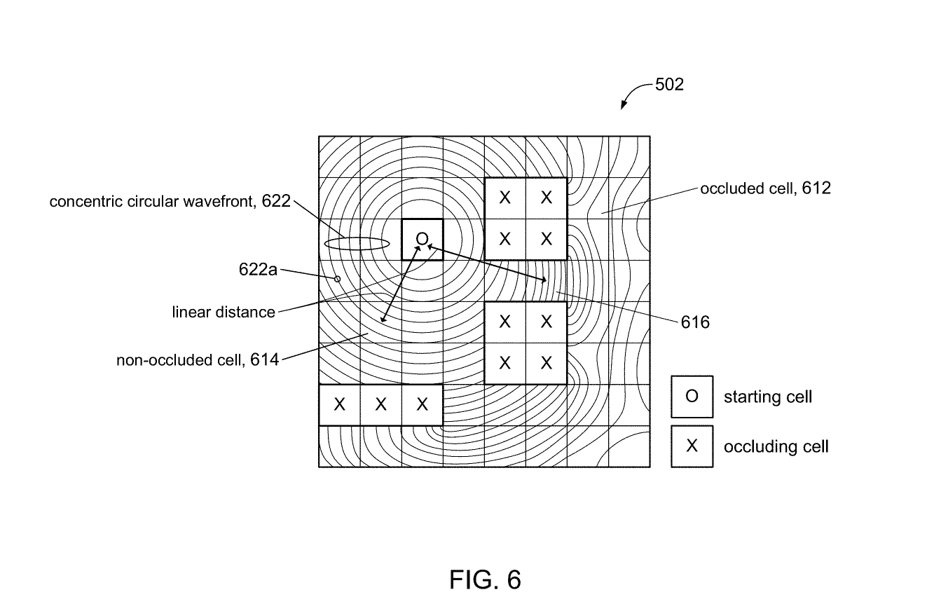

Referring to FIG. 6, the discussion will now turn to additional details about the processing in operations 410 and 412 (FIG. 4) for propagating a distance field and using the distance field to identify occluded cells. Propagation of the distance field can proceed like a wave that emanates from the starting cell. In some embodiments, the “path” between the starting cell and a non-occluding cell can be defined as the path of propagation of the wave between the cells. The path of propagation can represent a minimum-distance path between the starting cell and the non-occluding cell. Occlusions in the path of propagation, however, perturb the wave and cause the wave to wrap around the occlusions thus increasing the path of propagation between the starting cell and the non-occluding cell. Accordingly, propagation distance (or the path distance) between the starting cell and a non-occluding cell can be increased due to the presence of an intervening occluding cell(s).

In some embodiments, the linear distance between two cells can be considered a straight-line distance between the two cells. The linear distance, for example, can be computed using the Pythagorean theorem and treating each cell as a point (e.g., its center) on a Cartesian plane. The linear distance between the starting cell and cell 612, for instance, can be computed as the hypotenuse of a right triangle having sides of 4 units and 1 unit. Likewise, the linear distance of cell 614 can be computed as the hypotenuse of a right triangle having sides of 2 units and 1 unit, and so on for other non-occluding cells.

In some embodiments, the distance field can behave like a linear distance field when there are no occlusions along the path of propagation. As illustrated in FIG. 6, in some embodiments, the distance field can appear as a circular wavefront 622 comprising concentric circles when there are no occlusions. Accordingly, when there are no intervening occluding cells between the starting cell and a non-occluding cell such as cell 614, the path distance (determined from the propagated distance field) and the linear distance should be similar. In the case of circular propagating waves where the path distance of a cell is based on a circular wave 622a that passes through the center of the cell, the difference can be zero (i.e., the path distance and its linear distance may be equal).

By comparison, cell 612 can be deemed to be occluded from the line of sight of the starting cell. In the case of cell 612, where there are one or more intervening occluding cells between the cell and the starting cell, the propagating waves must go around the occluding cells thus lengthening the path of propagation from the starting cell to cell 612. Accordingly, the path distance of cell 612 can be significantly larger than its linear distance. Thus, for a given cell, when its path distance to the starting cell does not closely match its linear distance, that cell can be deemed to be occluded.

As discussed at operation 412, in some embodiments, a non-occluding cell (e.g., cell 612) can be deemed to be occluded from line-of-sight view of the starting cell if its path distance from the starting cell and its linear distance from the starting cell differ by an amount that exceeds a predetermined threshold. Conversely, when the difference is less that the predetermined threshold (as in the case of cell 614) the non-occluding cell can be deemed to be not occluded.

In some embodiments, the predetermined threshold can be determined empirically. In some embodiments, a consideration for setting the predetermined threshold can take into account that some cells may be deemed to be not occluded despite that the distance field propagated to some degree around one or more occluding cells. FIG. 6, for example, shows that cell 616 may be deemed to be not occluded, despite the presence of occluding cells that the wavefront partially wraps around, with the effect of slightly increasing the propagation path distance. The predetermined threshold can be set so that cells such as cell 616 can be deemed to not occluded even though the difference between their path distance and their linear distance is not zero. It will be appreciated that in other embodiments, the predetermined threshold can be determined based on any suitable criteria. In some embodiments, the predetermined threshold can be dynamically determined, and so can vary during the rendering process.

Since occlusion determination is based on distance fields and linear distances, the nature of the spatial partitioning should not be relevant. In some embodiments, for example, spatial partitioning of the scene can be represented by a discretized grid; e.g., as disclosed herein. The grid can be subdivided using a Cartesian coordinate system (e.g., as disclosed herein), or in other embodiments other subdivisions can be used (e.g., polar coordinates), and so on. In other embodiments, however, the spatial partitioning can be based on a continuous model representation of the scene instead of a discrete model.

FIG. 7 depicts a simplified block diagram of an example computer system 700 according to certain embodiments. Computer system 700 can be used to implement all or parts of the computer graphics engine 102 (FIG. 1), including the occlusion detector. As shown in FIG. 7, computer system 700 includes one or more processors 702 that communicate with a number of peripheral devices via a bus subsystem 704. These peripheral devices include a storage subsystem 706 (comprising a memory subsystem 708 and a file storage subsystem 710), user interface input devices 712, user interface output devices 714, and a network interface subsystem 716.

Bus subsystem 704 can provide a mechanism for letting the various components and subsystems of computer system 700 communicate with each other as intended. Although bus subsystem 704 is shown schematically as a single bus, alternative embodiments of the bus subsystem can utilize multiple busses.

Network interface subsystem 716 can serve as an interface for communicating data between computer system 700 and other computer systems or networks (not shown). Embodiments of network interface subsystem 716 can include, e.g., an Ethernet card, a Wi-Fi and/or cellular adapter, a modem (telephone, satellite, cable, ISDN, etc.), digital subscriber line (DSL) units, and/or the like.

User interface input devices 712 can include a keyboard, pointing devices (e.g., mouse, trackball, touchpad, etc.), a touch-screen incorporated into a display, audio input devices (e.g., voice recognition systems, microphones, etc.) and other types of input devices. In general, use of the term “input device” is intended to include all possible types of devices and mechanisms for inputting information into computer system 700.

User interface output devices 714 can include a display subsystem, a printer, or non-visual displays such as audio output devices, etc. The display subsystem can be, e.g., a flat-panel device such as a liquid crystal display (LCD) or organic light-emitting diode (OLED) display. In general, use of the term “output device” is intended to include all possible types of devices and mechanisms for outputting information from computer system 700.

Storage subsystem 706 includes a memory subsystem 708 and a file/disk storage subsystem 710. Subsystems 708 and 710 represent non-transitory computer-readable storage media that can store program code and/or data that provide the functionality of embodiments of the present disclosure; e.g., processing in FIG. 4.

Memory subsystem 708 includes a number of memories including a main random access memory (RAM) 718 for storage of instructions and data during program execution and a read-only memory (ROM) 720 in which fixed instructions are stored. File storage subsystem 710 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 700 is illustrative and many other configurations having more or fewer components than system 700 are possible.

The above description illustrates various embodiments of the present disclosure along with examples of how aspects of these embodiments may be implemented. The above examples and embodiments should not be deemed to be the only embodiments, and are presented to illustrate the flexibility and advantages of the present disclosure as defined by the following claims. For example, although certain embodiments have been described with respect to particular process flows and steps, it should be apparent to those skilled in the art that the scope of the present disclosure is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the present disclosure as set forth in the following claims.

What is claimed is:

1. An apparatus comprising:
one or more computer processors; and
a computer-readable storage medium comprising instructions for controlling the one or more computer processors to be operable to:
generate a spatial partitioning that is representative of a scene, the spatial partitioning comprising a plurality of cells including a starting cell, a plurality of occluding cells, and a plurality of non-occluding cells;
associate a path distance value for each non-occluding cell that is representative of a minimum path distance between said each non-occluding cell and the starting cell;
identify occluded cells from among the plurality of non-occluding cells using the minimum path distance value associated with each non-occluding cell and a linear distance value between said each non-occluding cell and the starting cell; and
produce a computer generated representation of the scene using non-occluding cells that are not identified as occluded cells.

2. The apparatus of claim 1, wherein identifying occluded cells includes, for each non-occluding cell, the one or more computer processors being operable to:
compute a difference between the minimum path distance value associated with said each non-occluding cell and the linear distance value between said each non-occluding cell and the starting cell; and
designate said each non-occluding cell as an occluded cell when the difference is greater than a predetermined value.

3. The apparatus of claim 1, wherein the spatial partitioning further comprises a starting set of cells, wherein the computer-readable storage medium further comprises instructions for controlling the one or more computer processors to be operable to select the starting cell from the starting set of cells.

4. The apparatus of claim 1, wherein associating a path distance value for each non-occluding cell comprises propagating a distance field from the starting cell using a fast marching algorithm.

5. The apparatus of claim 1, wherein the starting cell corresponds to a view point in the scene and the occluding cells correspond to objects in the scene.

6. The apparatus of claim 1, wherein producing the computer generated representation of the scene includes rendering only those non-occluding cells that are not identified as occluded cells.

7. The apparatus of claim 1, wherein producing the computer generated representation of the scene includes performing surface reconstruction using the non-occluding cells to produce a virtual reality scene, including omitting reconstruction of surfaces that correspond to non-occluding cells that are identified as occluded cells.

8. The apparatus of claim 1, wherein the computer generated representation of the scene is a scene in a computer game, wherein the computer-readable storage medium further comprises instructions for controlling the one or more computer processors to be operable to control an artificial intelligence game player to ignore objects corresponding to non-occluding cells that are identified as occluded cells.

9. A method for a computer generated scene, the method comprising:
generating a spatial partitioning that is representative of a scene, the spatial partitioning comprising a plurality of cells including a starting cell, a plurality of occluding cells, and a plurality of non-occluding cells;
associating a path distance value for each non-occluding cell that is representative of a minimum path distance between said each non-occluding cell and the starting cell;
identifying occluded cells from among the plurality of non-occluding cells using the minimum path distance value associated with each non-occluding cell and a linear distance value between said each non-occluding cell and the starting cell; and
producing a computer generated representation of the scene using non-occluding cells that are not identified as occluded cells.

10. The method of claim 9, wherein identifying occluded cells includes for each non-occluding cell:
computing a difference between the minimum path distance value associated with said each non-occluding cell and the linear distance value between said each non-occluding cell and the starting cell; and
designating said each non-occluding cell as an occluded cell when the difference is greater than a predetermined value.

11. The method of claim 9, wherein the spatial partitioning further comprises a starting set of cells, wherein the method further comprises selecting the starting cell from the starting set of cells.

12. The method of claim 9, wherein the starting cell corresponds to a view point in the scene and the occluding cells correspond to objects in the scene.

13. The method of claim 9, wherein producing the computer generated representation of the scene includes rendering only those non-occluding cells that are not identified as occluded cells.

14. The method of claim 9, wherein producing the computer generated representation of the scene includes performing surface reconstruction using the non-occluding cells to produce a virtual reality scene while omitting reconstruction of surfaces that correspond to non-occluding cells that are identified as occluded cells.

15. The method of claim 9, wherein the computer generated representation of the scene is a scene in a computer game, the method further including controlling an artificial intelligence game player to ignore objects corresponding to non-occluding cells that are identified as occluded cells.

16. The method of claim 9, wherein the spatial partitioning is a grid of cells.

17. A computer-readable storage medium having stored thereon computer executable instructions, which when executed by a computer device, cause the computer device to:
generate a spatial partitioning that is representative of a scene to be rendered, the spatial partitioning comprising a plurality of cells including a starting cell, a plurality of occluding cells, and a plurality of non-occluding cells;
associate a path distance value for each non-occluding cell that is representative of a minimum path distance between said each non-occluding cell and the starting cell;
identify occluded cells from among the plurality of non-occluding cells using the minimum path distance value associated with each non-occluding cell and a linear distance value between said each non-occluding cell and the starting cell; and
render the scene by rendering only those non-occluding cells that are not identified as occluded cells.

18. The computer-readable storage medium of claim 17, wherein identifying occluded cells includes for each non-occluding cell:
computing a difference between the minimum path distance value associated with said each non-occluding cell and the linear distance value between said each non-occluding cell and the starting cell; and
designating said each non-occluding cell as an occluded cell when the difference is greater than a predetermined value.

19. The computer-readable storage medium of claim 17, the spatial partitioning further comprises a starting set of cells, wherein the computer executable instructions, which when executed by the computer device, further cause the computer device to select the starting cell from the starting set of cells.

20. The computer-readable storage medium of claim 17, wherein the computer generated representation of the scene is a scene in a computer game, wherein the computer executable instructions, which when executed by the computer device, further cause the computer device to control an artificial intelligence game player to ignore objects corresponding to non-occluding cells that are identified as occluded cells.
